(19) United States
(12) Patent Application Publication
(10) Pub. No.: US 2005/0030660 A1
(43) Pub. Date: Feb. 10, 2005

(54) Amplitude spike detector for head instability

(76) Inventors: Ho-Yul Bang, Santa Clara, CA (US); Larry Ro, Sunnyvale, CA (US); Richard Wang, Fremont, CA (US); Jong Yun Yun, Cupertino, CA (US)

Correspondence Address: IRELL & MANELLA LLP, 840 NEWPORT CENTER DRIVE, SUITE 400, NEWPORT BEACH, CA, 92660, US

(21) Appl. No.: 10/638,029

(22) Filed: Aug. 8, 2003

(51) Int. Cl. G11B 27/36; G11B 5/09

(52) U.S. Cl. 360/31; 360/53; 360/25

(57) ABSTRACT

A hard disk drive that contains a self-test for generating data on head spikes. The data is stored on a system track of the drive. The self-test may be firmware embedded into a memory device of the drive. The self-test automatically runs when power is provided to the drive. This allows for a 100% spike detection test for disk drives assembled at a manufacturing facility. The self-test includes writing a test waveform, reading the test waveform and comparing the read waveform with a threshold to determine the existence of spikes. Data on the spikes is then stored on the system track. The data is compared with certain criteria to determine whether the disk drive is defective.

### BACKGROUND OF THE INVENTION

1. Field of the Invention

The present invention relates to a method for detecting head spikes in a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

Information is typically stored in radial tracks that extend across the surface of each disk. Each track is typically divided up into a number of segments or sectors. The voice coil motor and actuator arm can move the heads to different tracks of the disks.

The data written onto the disks has a waveform with numerous amplitude peaks. When reading the waveform the amplitude peaks are compared to a threshold to determine transitions used to decode the waveform into digital bit strings. Most disk drives contain an error correction code algorithm that detect and compensate for any errors in the data.

It has been found that the heads may degrade to a point where spikes appear in the waveform read from the disk. These spikes may create errors from missing pulses or high asymmetry that are not corrected by the error correction code but still corrupt the data stored in the drive. When this occurs the disk drive is typically tested by an operator who views the data waveform on an oscilloscope to visually detect the spikes. Visually detecting spikes on an oscilloscope is a time consuming test procedure. Additionally, such an approach cannot be performed on every disk drive, thereby increasing the probability that a defective disk drive is shipped from a manufacturing facility. It would be desirable to automatically conduct a 100% test for head spike detection.

### BRIEF SUMMARY OF THE INVENTION

A hard disk drive with a self-test program that generates data on head spikes. The data is stored on a system track of the disk drive.

### BRIEF DESCRIPTION OF THE DRAWINGS

FIG. 1 is a top view of an embodiment of a hard disk drive;

FIG. 2 is a schematic of an electrical circuit for the hard disk drive;

FIG. 3 is a schematic of a read channel of the electrical circuit;

FIG. 4 is a flowchart of a self-test for detecting head spikes and storing the head spike data on a system track of the disk drive;

FIG. 5 is a schematic showing a waveform written onto a disk;

FIG. 6A is a diagram showing the detection of peaks that exceed a threshold;

FIG. 6B is a graph showing a full detected waveform;

FIG. 7 is a graph showing a simulation of a data pattern;

FIG. 8A is a graph showing actual data;

FIG. 8B is a graph showing actual data that exceeds a threshold.

### DETAILED DESCRIPTION

Disclosed is a hard disk drive that contains a self-test for generating data on head spikes. The data is stored on a system track of the drive. The self-test may be firmware embedded into a memory device of the drive. The self-test automatically runs when power is provided to the drive. This allows for a 100% spike detection test for disk drives assembled at a manufacturing facility. The self-test includes writing a test waveform, reading the test waveform and comparing the read waveform with a threshold to determine the existence of spikes. Data on the spikes is then stored on the system track. The data is compared with certain criteria to determine whether the disk drive is defective.

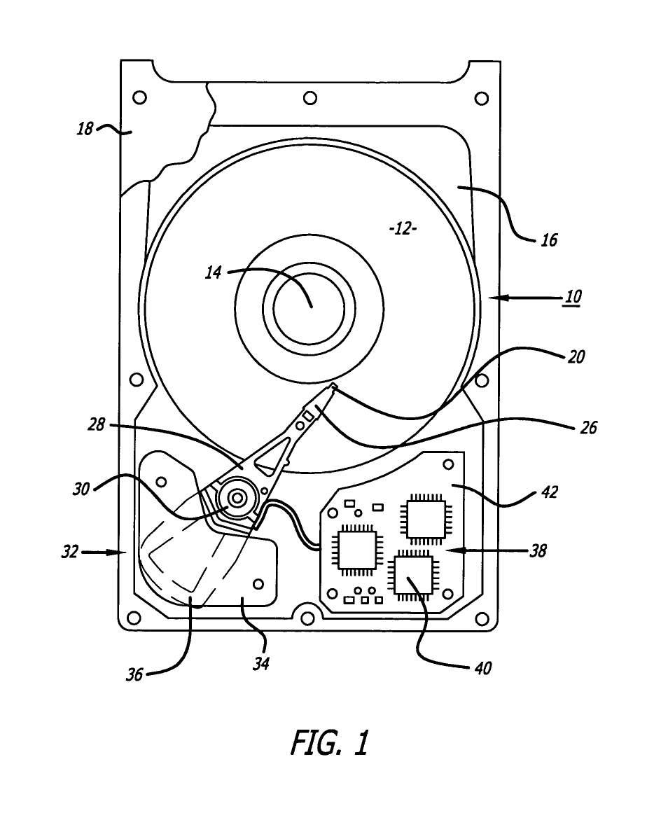

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

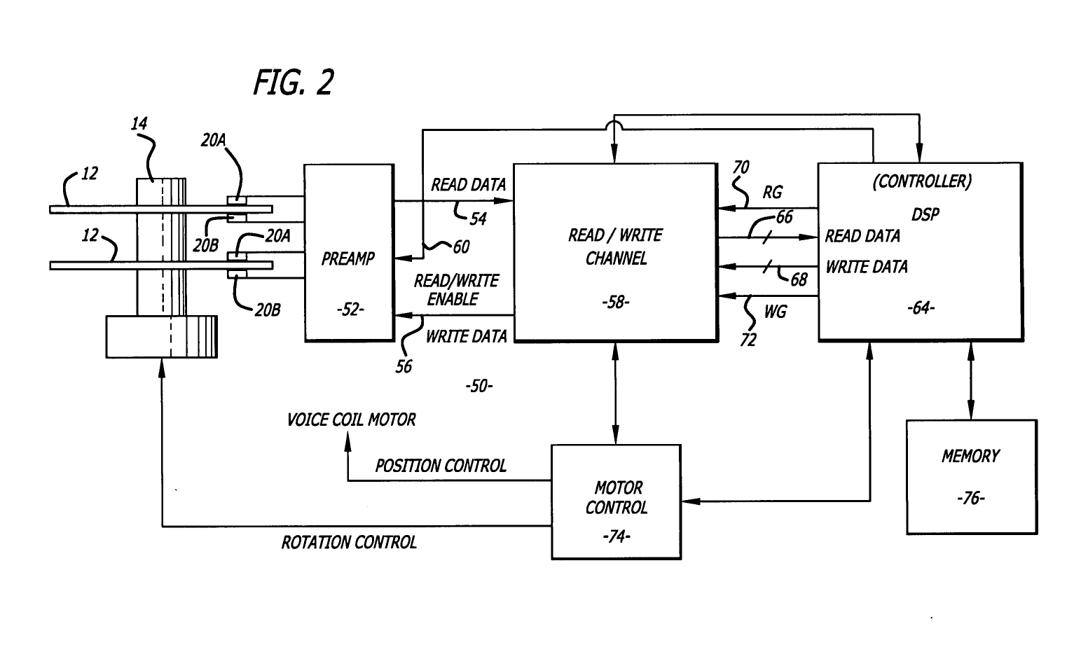

FIG. 2 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”).

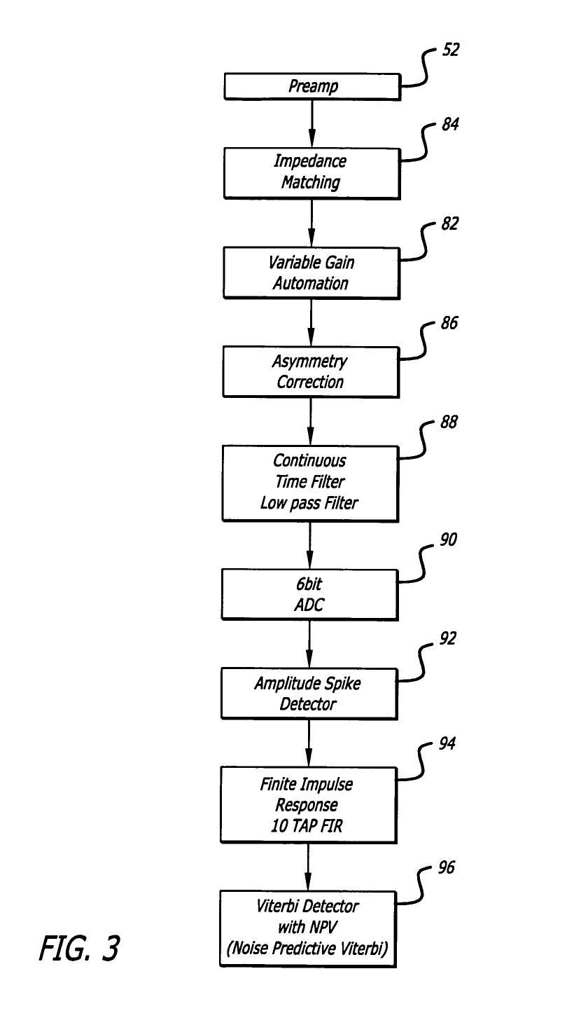

FIG. 3 is a block diagram showing the different functional circuits for reading a disk. The functional circuits include an automatic gain control (AGC) circuit 82 coupled to the pre-amplifier 52 by a impedance matching circuit 84. The AGC circuit 82 provides automatic gain control of the waveform read from the disk.

The functional circuits may further contain an asymmetry correction circuit 86, a continuous time low pass filter 88, and an analog to digital converter 90 that condition, filter and convert the waveform to a digital bit string. An amplitude spike detector 92 determines the existence of amplitude spikes in the signal. The bit string is provided to a finite impulse response (FIR) circuit 94 that provides finite impulse responses. The data is further provided to a viterbi detector 96, preferably a noise predictive viterbi.

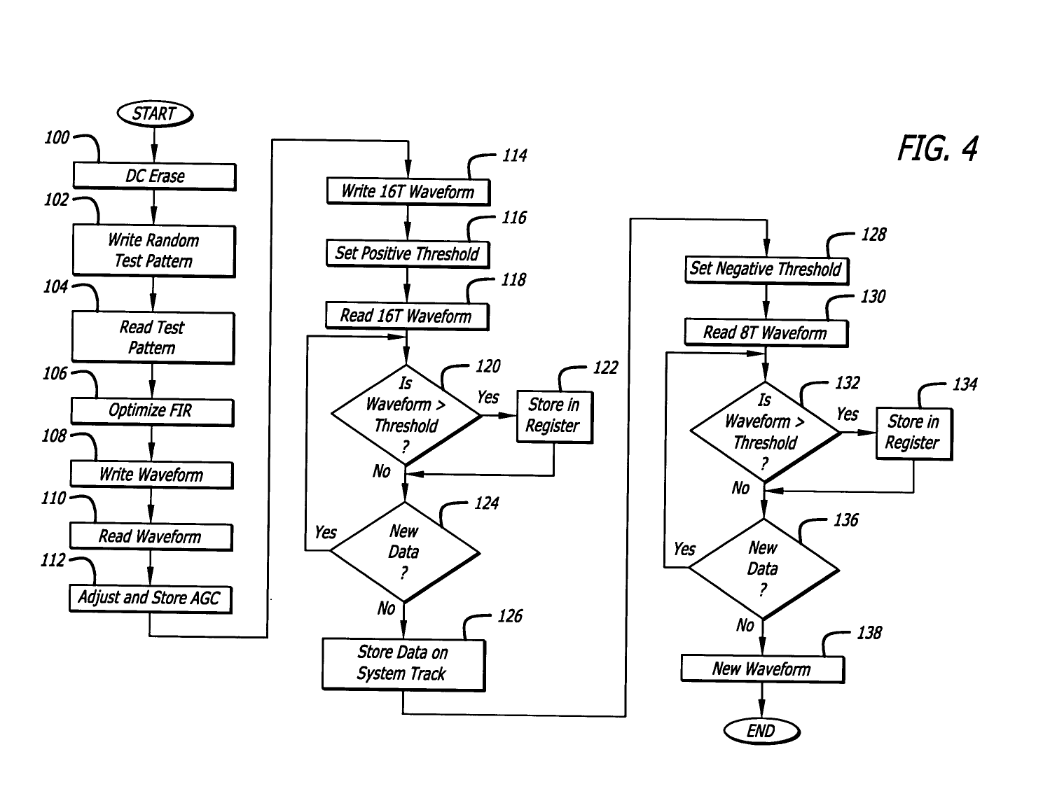

FIG. 4 is a flowchart for a self-test that is used to generate data on head spikes. The data is stored on a system track of the disk. The self-test may be firmware that is embedded into the memory 76 of the drive. When the disk drive is initially assembled at a manufacturing facility the drive is placed in a self-test bench. The self-test bench provides power to the disk drive. The drive initially boots up and runs the self-test. The entire self-test may contain a number of different internal tests such as determining head parameters and bit error rates.

The self-test spike detection routine includes DC erasing disk tracks N−1, N, N+1 at block 100 and then writing a test pattern of random data onto track N in block 102. In block 104 the random test pattern of track N is read. The test pattern is read back and used to optimize the FIR in block 106.

A new random pattern is written onto the track N, read back and used to adjust the AGC circuit in blocks 108, 110 and 112. The adjusted AGC value is stored onto a system track or memory of the drive.

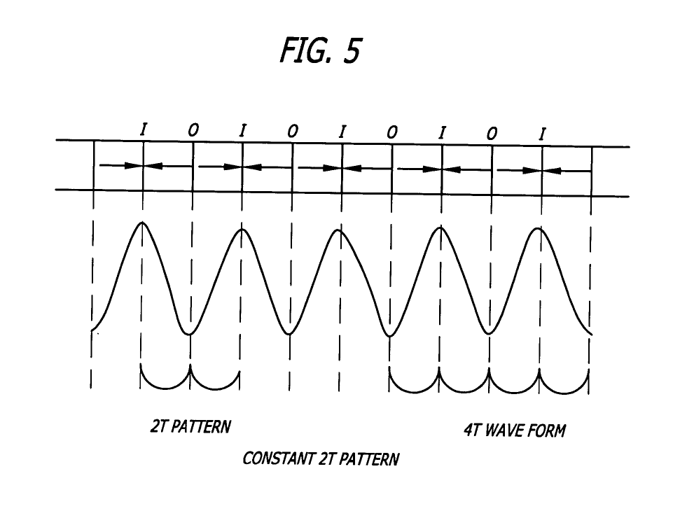

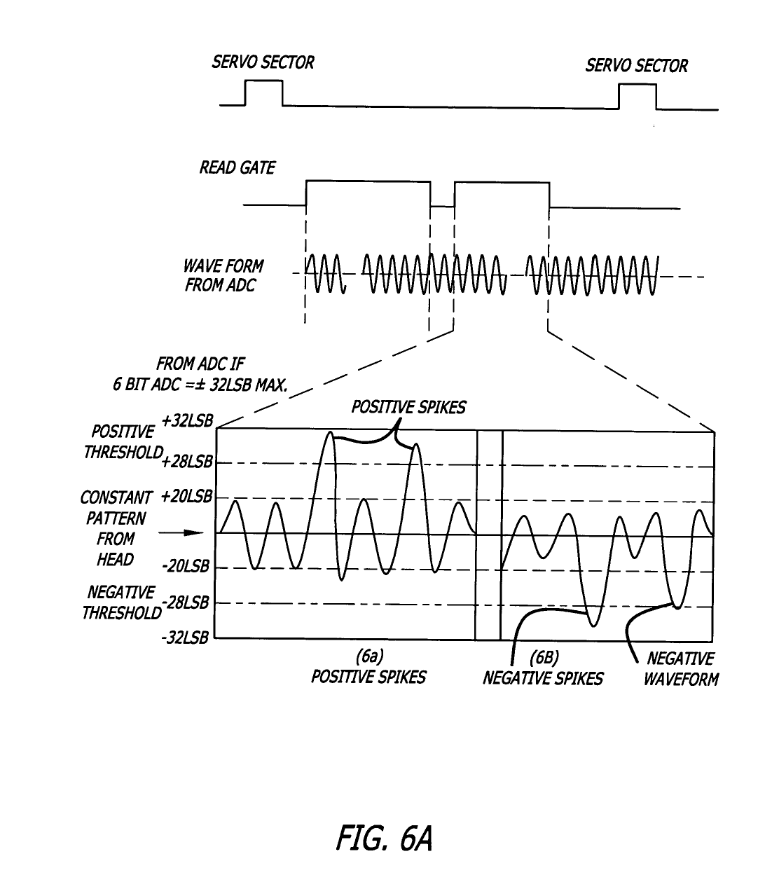

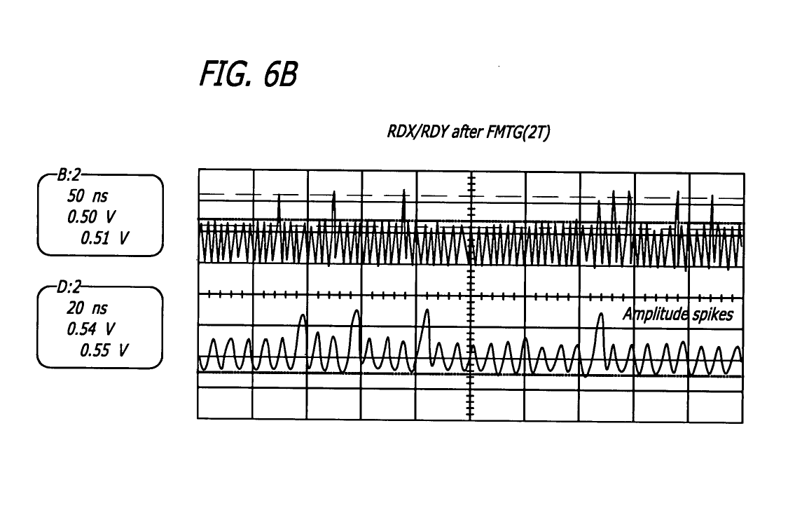

In block 114 a new constant waveform is written onto track N. By way of example, the waveform may be an 8T pattern (16T waveform). A 2T waveform is shown in FIG. 5. The T relates to the number of “0”s between “1”s of the data. A positive threshold may be set in block 116. The 16T waveform is then read and compared to the threshold in blocks 118 and 120. If the waveform has peaks that exceed the threshold, the peak is determined to be a spike and this data is stored in a register in decision block 122. A diagram showing peak detection is depicted in FIG. 6A. The ADC has a 6 bit resolution and it can be set at +/−32LSB max. A larger waveform is shown in FIG. 6B. Block 124 determines whether there is any new data. If there is no more data the positive head spike data is stored in a system track of the disk drive in block 126.

In block 128 the threshold is changed to a negative value and the steps of reading, comparing, determining, and permanently storing the data on the negative head spikes is performed in blocks 130, 132, 134 and 136. When the test is completed a new waveform is written onto track N in block 138 and the self-test spike subroutine ends.

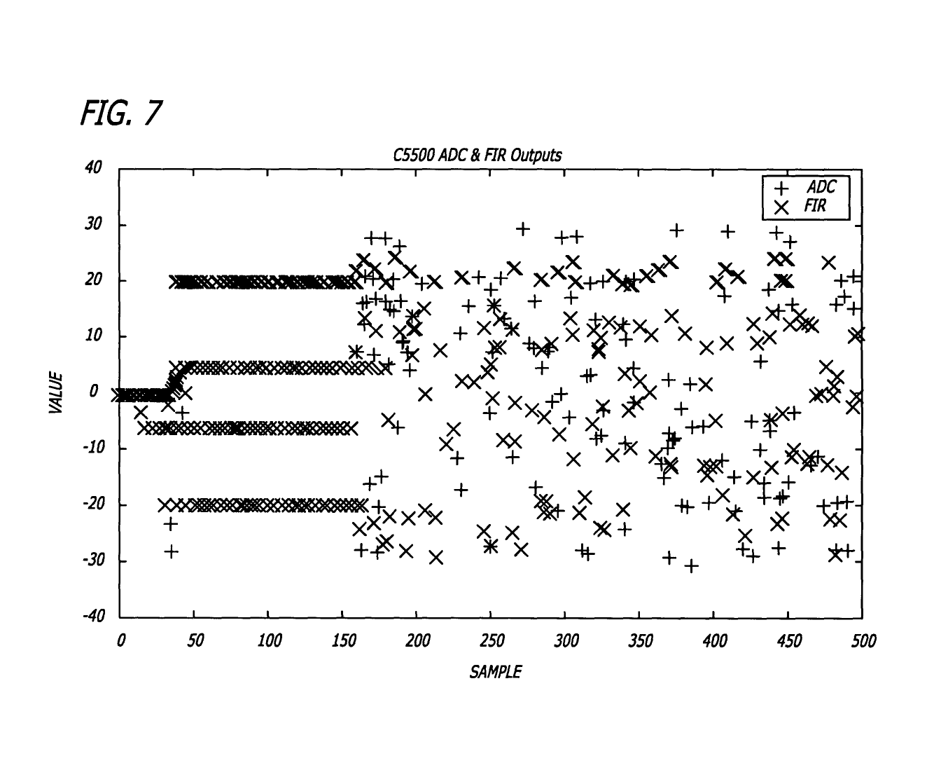

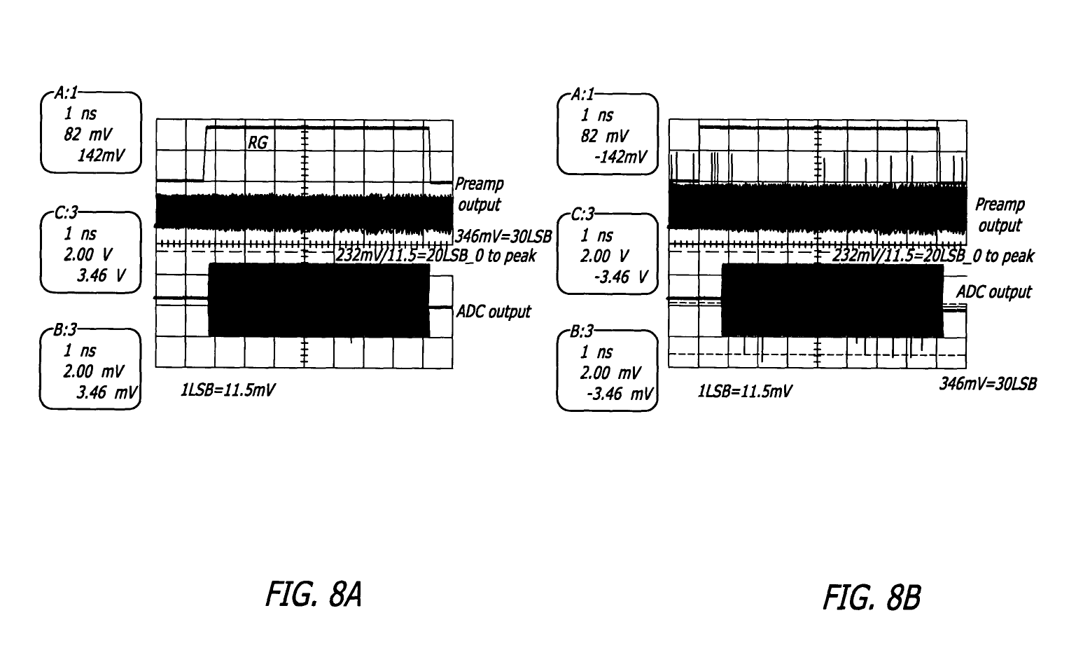

FIG. 7 shows a simulation of a data pattern. FIGS. 8A and 8B show actual data with a constant pattern and head spikes, respectively.

When the test is done the spike data can be read and compared to certain test criteria. By way of example, valid data for a 2T pattern may provide a normal ADC output of +/−20 LSB. The threshold can be set at +/−30 LSB. Any amplitude spike that exceeds this threshold is reported as an error. If the data exceeds a certain criteria the disk drive can be labeled defective and either repaired or scrapped. If the disk drive is shipped, the boot-up routine of the drive will initially read the system track. If there is system self-test data on the system track the boot-up routine will skip the self-test routine in the drive.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A hard disk drive, comprising:
a disk having a system track that contains head spike data;
a spindle motor that rotates said disk;
a head coupled to said disk;
a read channel coupled to said head;
an actuator arm coupled to said head;
a voice coil motor coupled to said actuator arm; and,
a controller coupled to said read channel.

2. The disk drive of claim 1, further comprising a memory coupled to said controller, said memory containing a self-test program that generates said head spike data.

3. The disk drive of claim 2, wherein said self test program writes and reads a waveform from said disk, and compares said waveform to a threshold to determine a spike.

4. The disk drive of claim 3, wherein said threshold is a positive value.

5. The disk drive of claim 3, wherein said threshold is a negative value.

6. A hard disk drive, comprising:
a disk;
a spindle motor that rotates said disk;
a head coupled to said disk;
a read channel coupled to said head;
an actuator arm coupled to said head;
a voice coil motor coupled to said actuator arm; and,
a controller coupled to said read channel; and,
a memory device that is coupled to said controller and contains a self-test program that generates data on head spikes.

7. The disk drive of claim 6, wherein said self test program writes and reads a waveform from said disk, and compares said waveform to a threshold to determine a spike.

8. The disk drive of claim 7, wherein said threshold is a positive value.

9. The disk drive of claim 7, wherein said threshold is a negative value.

10. A hard disk drive, comprising:
a disk;
a spindle motor that rotates said disk;
a head coupled to said disk;
a read channel coupled to said head;
an actuator arm coupled to said head;
a voice coil motor coupled to said actuator arm;
a controller coupled to said read channel; and,
means for generating data on head spikes.

11. The disk drive of claim 10, wherein said means includes a self test program that writes and reads a waveform from said disk, and compares said waveform to a threshold to determine a spike.

12. The disk drive of claim 11, wherein said threshold is a positive value.

13. The disk drive of claim 11, wherein said threshold is a negative value.

14. A method to generate data on head spike detection for a hard disk drive, comprising:
writing a waveform onto a track of a disk;
reading the waveform;
comparing the waveform to a threshold to determine the existence of a spike; and,
storing data on the spike.

15. The method of claim 14, wherein the data is stored in a system track of the disk.

16. The method of claim 14, wherein the writing, reading, comparing and storing are performed in accordance with a self-test program that is stored in a memory of the hard disk drive.

17. The method of claim 14, wherein the threshold is a positive value.

18. The method of claim 14, wherein the threshold is a negative value.
